(19) United States
(12) Patent Application Publication
(10) Pub. No.: US 2010/0139505 A1
(43) Pub. Date: Jun. 10, 2010

(54) COMPONENT FOR A MACHINE USED FOR PROCESSING FOODS

(76) Inventors: Tobias Graf, Auenstein (CH); Markus Glauser, Nurensdorf (CH)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/599,816

(22) PCT Filed: May 4, 2008
(86) PCT No.: PCT/CH08/00201

§ 371 Date: Nov. 12, 2009

(30) Foreign Application Priority Data
May 11, 2007 (CH) 766/07

(51) Int. Cl. A47J 43/00; C08K 3/08; B32B 15/08

(52) U.S. Cl. 99/646 R; 523/122; 428/457

(57) ABSTRACT

In a component whose use in machines in the food industry is established, this component has a surface (2) which forms an active plane with the food products. This surface is a constituent part of a base material which has those physical properties which correspond to its intended use. This base material also has other properties, which properties ensure homogeneous dispersion of nanoscale particles of a bacterial and/or fungicidal substance.

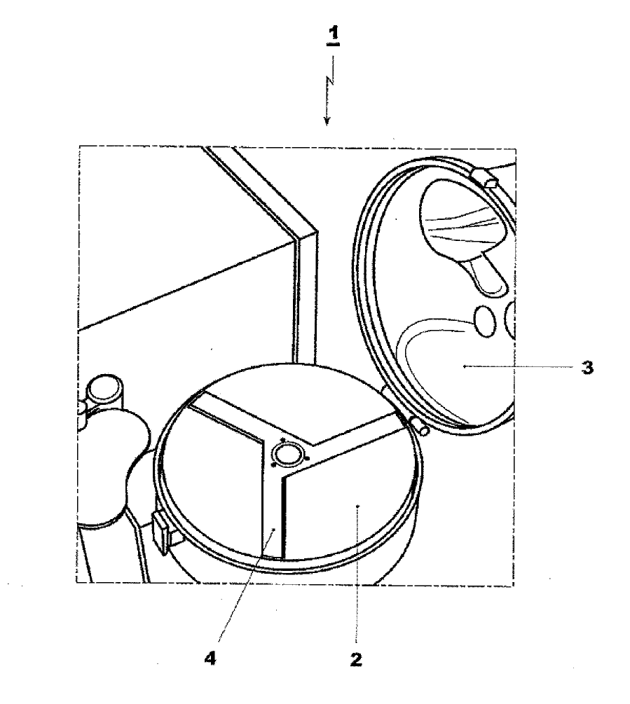

### BACKGROUND OF THE INVENTION

1. Field of the Invention

The present invention relates to a component for a machine that is used for processing foods. It also relates to a method for producing such a component and to the use or utilization of such a component or method.

2. Description of the Prior Art

In the food industry as it relates to preparing fruits and vegetables, etc., by cutting, chopping, crushing, etc., steels, and frequently aluminum alloys, as well, are used for surfaces that come into contact with these foods, always with the final goal of achieving the best possible mechanical resistance to wear and very good chemical resistance to acids, bases, salts, etc. Even when the exposed surfaces, that is, the surfaces that are involved in the processing, have pleasing surface quality when they are first used and therefore seem to be of high quality, it is unavoidable that these surfaces are gradually subjected to substantial wear when processing foods due to the mechanical loads that occur on them. Due to the micropores or macropores that form, this surface wear rapidly leads to a bacteriological load on the surface. This has an immediate effect on the foods processed on the surface which can cause a not insubstantial quantity of these foods to be infected with bacteria which is particularly intolerable when these foods are to be used raw in dishes. Laboratory tests in hospitals on machines used to process foods have clearly demonstrated that such surfaces can even become infected with resistant bacteria very rapidly so that increasingly strong disinfectants must be used with increasing frequency to provide some measure of protection to ensure that the bacteriological load cannot get out of hand and lead to collateral health problems, especially in patients who are weak or have just had surgery.

However, this enormous undertaking with increasingly strong disinfectants inevitably leads to resistant strains of bacteria and furthermore to the gradual deterioration of the surface quality of these parts themselves, which then contributes to colonies of bacteria being able to easily take hold on surfaces, which can lead to serious hygiene problems and to unintended health consequences. Moreover, it must not be forgotten that the solution frequently used for this—repeatedly treating the surface with increasingly strong disinfectants shortly before use—can entail additional significant health risks. Furthermore, it should not be forgotten that large processing surfaces are being used, especially in the food industry, so that the health risks increase disproportionately.

### SUMMARY OF THE INVENTION

The invention remedies this situation. The underlying goal of the invention is to provide a surface that has an active antimicrobial effect for components of food processing machines. The surface comprises an extremely wear-resistant material, while at the same time this material is suitable for having bactericidal and/or fungicidal substances mixed in such that the aforesaid disadvantages can be eliminated integrally in the processor surfaces of the prior art.

When speaking of a bactericidal effect, this is understood to include the destructive effect of a substance, material, or alloy on bacteria.

Materials that have a fungicidal effect, in which such an effect is advantageous when providing active surfaces, are inventively included in the following, but will not be specifically mentioned again in each instance.

A bactericidal and/or fungicidal effect shall also be called an antimicrobial effect hereafter in the application.

In accordance with the invention, a plastic, preferably a product with a polymer basis, is used having incorporated nanoadditives having bactericidal and also fungicidal properties based upon the findings that polymers of the most recent generation have excellent mechanical properties, first-class chemical resistance, and provide stable thermal and electrical properties so that their use in this field is absolutely appropriate and advantageous.

Nevertheless, proceeding from the object of the invention, hurdles had to be overcome and technical problems had to be resolved to completely accomplish teaching on the technical aspect of the invention.

1. The lack of know-how for safe and economic production of compoundable bactericidal nanoparticles that best integrate homogeneously in suitable plastics (polymers) with respect to mixing directly in the plastic, the interdependence between the basic plastic and the desired addition of the additive can be seen. Compounding is a term from plastics engineering and describes the processing of plastics by mixing in additives for optimizing the profile of properties in a specific manner.
2. Since the required concentration of bactericidal nanoparticles in the plastic is very small in order to have the desired effect, specifically a 100% destruction rate for the bacteria that occur most frequently, until now the nanopowder could not be distributed correctly and homogeneously in all of the plastic during production of the inventive surface. Moreover, publications have mentioned the fact that the low bactericidal concentration required could not be distributed correctly and homogeneously in the entire plastic in the processes used. Nanoparticle engineering has to do with particles that can be measured in 100 billionths of a meter that to date possess unknown chemical and physical properties.
3. Thus, one major problem when using nanomaterials according to instructions is the nanomaterials' tendency to form agglomerates, aggregates, and clusters during use. Under these conditions there is a sharp reduction in the active surface area and thus also a sharp reduction in the degree of bactericidal effect that derives from these added substances.
4. Another problem, however, has to do with the adhesion of the nanomaterials that are added in conjunction with the use of the active surface when processing foods.

The desired homogeneity can only be attained if the process technology problem when nanoparts are added to the plastic is successfully solved, specifically creating a remedy for the risk of agglomerate, aggregate, and cluster formation, which implies that in addition to suitable production methods for the plastic there must also be suitable nanoparts that can be mixed into the plastic appropriately.

In accordance with the invention, the problems outlined above are solved in that the concentration of the bactericidal and/or fungicidal material, which is low per se, is added to the polymers such that the final product can be used correspondingly.

A basis is required for attaining a homogenous and adhesive distribution of the antimicrobial substance that has been mixed in so that a maximally active surface can be attained for the polymer that will be used. The distribution is directly related to the bactericidal and fungicidal effect by mechanical mixing of the corresponding pulverized polymers with the bactericidal/fungicidal nanoparts, with the nanoparts being in the colloidal state. The quality of the pulverized polymer is closely related to the nanoparts that have been mixed therein.

Colloids are the smallest particles into which a material can be divided without losing their individual properties. A colloid is a system made of clusters (up to 50,000 atoms) that are finely distributed in a medium. Moreover, these colloids which are made of noble metals remain very stable under widely varying conditions, without possible detection of chemical decomposition. This colloidal stability is critical for the employment and effect of this substance as bactericidal particles because the selection of this particle size is crucial for ensuring that colloidal stability occurs that then prevents the formation of aggregates, agglomerations, and clusters.

This mechanical mixture can be attained preferably in conjunction with an extrusion process by extrusion involving plastics or other semi-liquid hardenable materials being pressed through a die in a continuous process. After exiting the die, the plastic hardens, generally in a water-cooled calibration.

As far as the plastic is concerned, in accordance with the invention the basis is a linear, aromatic, crystalline, or quasi-crystalline polymer that offers the best opportunities for successfully adding nanoscale particles to create a case-hardened bactericidal polymer.

There are two aspects to the suitability of this polymer, and therefore its advantages: Firstly, this polymer ensures that the bactericidal and fungicidal particles are successfully included, and secondly, this polymer is very efficient. Thus in terms of its resistance to wear, there have been experiments in which no measurable particle abrasion was detected given proper use. Moreover, the strength and other mechanical properties of this polymer are designed such that no limitations are found that would argue against its inventive use. The polymer's purity and extremely low extractability favor this polymer as being extremely suitable for contact with foods. Its chemical resistance is also excellent, so that it is inert in the great majority of chemical environments, is insensitive to steam, and absorbs practically no moisture, which proves very advantageous, especially when processing fruits and vegetables. Its electrical insulation is also stable. Its heat resistance is intact up to temperatures of 250° C. Furthermore speaking in favor of the use of this polymer in the invention is its pronounced excellent adhesiveness compared to another substrate that can be used, so that the components employed do not necessarily have to comprise a single polymer body but there is also the option of basing a layer of this polymer on a substrate.

Additional experiments have demonstrated that, in addition to the linear polymers, polymers that have a branched or networked structure have also led to correspondingly good results depending on the use.

Moreover, experiments have demonstrated that the specific additives can be successfully used as carriers in order to achieve better dosing and distribution of the bactericidal substance when needed and for increasing the strength of the polymer itself according to use.

If silver by itself is mentioned above in a few embodiments as a material having a bactericidal effect, it should also be stated that other metals like gold, copper, etc. also have a bactericidal effect. Also possible are alloys made of silver and gold as well as copper and gold. Silver-copper alloys are not as promising.

In this regard, laboratory trials have demonstrated that for the “silver” bactericidal substance a concentration of 0.01 to 1 wt. % in most cases is entirely adequate to attain a 100% destruction rate for the most frequently occurring bacteria. More intense concentrations of up to 5 wt. % are not out of the question, depending on the use and traced effect.

In accordance with the invention, it is also possible to homogeneously disperse two or more colloidal bactericidal materials in the polymers, the dispersion describing uniform distribution in which the goal of the process is to attain complete fragmentation of any agglomerate that forms, to attain uniform distribution of the primary particles in the system, and to attain permanent stabilization of this condition.

The potential applications or uses of the inventive subject-matter are advantageously found in circumstances in which the goal is to provide a lasting remedy against infection by bacteria and fungicides when processing foods.

The following list relates to employment possibilities for the invention, this list not being exhaustive:
vegetable cutting machines
cutters
citrus presses
juice centrifuges
slicers
food processors
other food processing machines.

The invention can also be employed in other applications in food processing.

Advantageous and useful further refinements of the invention are possible.

In the following, one exemplary embodiment of the invention is explained in greater detail using the drawing. All of the features that are not essential for immediate understanding of the invention have been omitted.

### BRIEF DESCRIPTION OF THE DRAWING

The single FIGURE depicts a segment of a vegetable cutting machine with corresponding cutting disks.

### DETAILED DESCRIPTION OF THE INVENTION

The FIGURE depicts a typical use for the invention. In a vegetable cutting machine 1, especially the cutting disk 2 is being re-defined in terms of material. This shall not be construed to apply exclusively to the cutting disk, because the other surfaces of such machines, for instance the cover surface 3, can also use the invention.

The cutting disk 2 comprises a polymer that during production has added to it nanoadditives that have bactericidal properties, and that thus ensure that the bacteria are destroyed immediately. Naturally fungicidal nanoadditives can also be added (substances that have a fungicidal effect are included in the following observations and are therefore not excluded).

If the cutting disk 2 now is produced from such a polymer and used to replace the normal metal parts, the physical material properties for such a polymer are not inferior compared to those of the special steels that are normally used. This means that it is not only the mechanical properties that are affected, but there must also be first-class chemical resistance, and moreover this polymer must have stable thermal and electrical properties. Such requirements are satisfied by a linear, aromatic, crystalline, or quasi-crystalline polymer, and sometimes a branched or networked polymer can be used. This polymer is particularly distinguished by its high resistance to wear with regard to particle abrasion, bearing in mind the fact that when the food is being processed high shear forces occur in the area of the blade 4 that is integrated in the cutting disk 2, and these shear forces could easily cause particle abrasion if the polymer did not have the necessary resistance to wear. In our case this polymer can be used with no limitations in this respect.

Moreover, the polymer that is used for the cutting disk 2 has the property that it can best be mixed with antimicrobial (bactericidal and/or fungicidal) substances such that the antimicrobial materials that have been mixed into such a cutting disk 2 are homogeneously distributed, and thus the requirement for maximized effect against microbes that occur is satisfied, which would not be the case if the bactericidal and fungicidal materials had a tendency to agglomeration, aggregation, or cluster formation during the mixing process because then the antimicrobial effect of the surface would be sharply limited.

Thus it is indicated that not just the properties of the polymer, but in addition the bactericidal substances that are used must be present in a condition that enables the properties desired in the final product. This can be attained in that colloidal particles of the bactericidal material are used, which particles make possible maximum distributive homogeneity in the mechanical mixture with the basic material of the polymer and which distributive homogeneity is a fundamental requirement so that the bactericidal effect is uniform and constant across the entire surface of the cutting wheel. A good mechanical mixture can be attained when the polymer is produced in an extrusion method.

The bactericidal effect of the substance shall be briefly illustrated using the example of colloidal particles of silver. The active substances here are the silver ions that detach from the silver surface, thus initiating the bactericidal effect. This now completes the information presented above in that at that point an active surface is described that must have these particles added to it homogeneously in order to obtain the greatest possible bactericidal effect. These silver ions have the ability to attack bacteria cells at different locations simultaneously and thus to disable them. The strong effect of these silver ions can be seen in that they attack at least cell wall, cell membrane, proteins, enzymes, and DNA of these bacteria cells, blocking or destroying essential cell components. The silver ions attacking the bacteria cells at multiple locations prevent any compensating resistances. That is, the bacteria are no longer able to develop a suitable resistance against the silver ions, which is relevant when held against the problematics of strains that are resistant to antibiotics.

Another surprising effect when using colloidal particles made of silver is the extremely small quantity that is required for a 100% destruction rate for the bacteria. Laboratory trials have demonstrated that a destruction rate of 100% against the microorganisms that typically occur with foods can be attained with a concentration of just 0.01-1.0 wt. % silver in the entire polymer. If a more severe microorganism infection is expected, the concentration can be increased with nothing further, additional trials having shown that starting at approx. 5% the antimicrobial effect experiences asymptotic flattening.

Because of the high resistance to wear of the polymer used and due to the low quantities of the elementary silver that is added, the latter is completely harmless for humans, especially because the quantity of silver ions released is extremely small, but precisely these low quantities are sufficient for rendering microorganisms harmless. No toxic hazards for humans have become known when using silver, either.

In other words, compared to other antiseptics, silver has the advantage that it has a lasting effect against a broad spectrum of bacteria/fungicides, even at very low concentrations, without being toxic.

Mixing in a bactericidal material is not limited to silver. Other materials, for instance gold, copper, etc. have antimicrobial (bactericidal, fungicidal) properties, it being possible to use these materials on a case by case basis alone, in combination with one another, or as alloys.

1-15. (canceled)

16. A component of a machine used for processing foods, comprising at least one plane, directly affected by or impacted by different foods, the at least one plane including an active antimicrobial surface, comprising a plastic, the plastic having physical and chemical properties which provides an active surface in the machine, and wherein the plastic includes a homogenous dispersion of nanoscale particles of an antimicrobial substance mixed therein.

17. A component in accordance with claim 16, wherein the component comprises one of at least one body of the plastic, or the plastic comprises an active surface applied to a base material.

18. A component in accordance with claim 17, wherein the base material is steel.

19. A component in accordance with claim 16, wherein the plastic comprises a linear, aromatic, crystalline, or quasi-crystalline polymer.

20. A component in accordance with claim 16, wherein the plastic comprises a branched or networked, aromatic, crystalline, or quasi-crystalline polymer.

21. A component in accordance with claim 16, wherein the antimicrobial substance comprises at least one of bactericidal and fungicidal particles.

22. A component in accordance with claim 16, wherein the antimicrobial particles are mixed in a colloidal form into the plastic.

23. A component in accordance with claims 16, wherein colloidal silver comprises the particles.

24. A component in accordance with claims 17, wherein colloidal silver comprises the particles.

25. A component in accordance with claims 18, wherein colloidal silver comprises the particles.

26. A component in accordance with claims 19, wherein colloidal silver comprises the particles.

27. A component in accordance with claims 20, wherein colloidal silver comprises the particles.

28. A component in accordance with claims 21, wherein colloidal silver comprises the particles.

29. A component in accordance with claims 22, wherein colloidal silver comprises the particles.

30. A component in accordance with claim 23, wherein the colloidal silver particles are in a portion of 0.01-5 wt. % of the plastic.

31. A component in accordance with claim 16, wherein the particles comprise at least one of colloidal silver, gold and copper.

32. A component in accordance with claim 16, wherein the particles comprise alloys of at least one of colloidal silver and gold and colloidal gold and copper.

33. A method for producing a component in accordance with claim 16, comprising mixing the antimicrobial colloidal particles into a pulverized powder of the plastic using a mechanical mixing process to provide a homogenous dispersion of the antimicrobial colloidal particles in the plastic.

34. A method in accordance with claim 33, wherein mixing of plastic and the particles is performed in an extrusion process.

35. A method in accordance with claims 37, wherein the mixing is performed while adding at least one additive providing a maximized dispersion of antimicrobial colloidal particles in the plastic.

36. A use of the component in accordance with claim 16 comprising a vegetable cutting machine.
